(19) United States
(12) Patent Application Publication
(10) Pub. No.: US 2023/0098261 A1
(43) Pub. Date: Mar. 30, 2023

(54) APPARATUS AND METHOD FOR SUPPORTING MOBILITY OF TERMINAL IN WIRELESS COMMUNICATION SYSTEM

(71) Applicant: Samsung Electronics Co., Ltd., Gyeonggi-do (KR)

(72) Inventor: Kyungjoo SUH, Gyeonggi-do (KR)

(21) Appl. No.: 17/954,790

(22) Filed: Sep. 28, 2022

(30) Foreign Application Priority Data
Sep. 28, 2021 (KR) 10-2021-0128347

(51) Int. Cl. H04W 48/18; H04W 76/38; H04W 60/04

(52) U.S. Cl. CPC H04W 48/18; H04W 76/38; H04W 60/04; H04W 84/042

(57) ABSTRACT

Provided is a method performed by a user equipment (UE), the method including receiving roaming information including visited public land mobile network (PLMN) information from an access and mobility management function (AMF); selecting a PLMN among at least one PLMN identified based on verification of the received roaming information; transmitting a message to release a protocol data unit (PDU) session previously established at the UE to a session management function (SMF); performing PDU session release based on a response message for the transmitted message; and transmitting a message to register the selected PLMN.

### CROSS-REFERENCE TO RELATED APPLICATION(S)

This application is based on and claims priority under 35 U.S.C. § 119 to Korean Patent Application No. 10-2021-0128347, which was filed in the Korean Intellectual Property Office on Sep. 28, 2021, the entire disclosure of which is incorporated herein by reference.

### BACKGROUND

### 1. Field

The disclosure relates generally to a method and apparatus for supporting mobility of a terminal in a wireless communication system and, more particularly, to an apparatus and method for supporting roaming in 5th generation (5G) mobile communications technologies.

### 2. Description of the Related Art

Looking back on the progress of wireless communication generations, technologies for human-centric services, such as voice, multimedia, and data services, have mainly been developed A trend of explosive increase after commercialization of the 5G communication systems is expected for devices that will be connected to a communication network, e.g., vehicles, robots, drones, home appliances, displays, smart sensors installed in various infrastructures, construction machines, and factory equipment. Mobile devices are expected to evolve into various forms, such as augmented reality glasses, virtual reality headsets, and hologram devices. In a 6th-generation (6G) era, efforts are being made to develop an improved 6G communication system to provide various services by connecting hundreds of billions of devices and things. For this reason, the 6G communication system is called a beyond 5G system.

The 6G communication system is expected to be realized around 2030, with a maximum data rate of tera (that is, 1,000 gigabytes) bps and wireless latency of 100 microseconds (μsec). Compared to the 5G communication system, the 6G communication system is expected to provide a data rate that is 50 times faster and the wireless latency is reduced to one-tenth.

To achieve such a high data rate and ultra-low latency, the 6G communication system is expected to be realized on a terahertz band (e.g., 95 gigahertz (GHz) to 3 terahertz (3THz) band). In the terahertz band, compared to the millimeter wave (mmWave) band introduced in the 5G, due to more severe path loss and atmospheric absorption, it can be expected that technology that can guarantee the signal reach, i.e., coverage, will be more important. To ensure coverage, multi-antenna transmission technologies such as new waveforms, beamforming, and massive multiple-input and multiple-output (massive MIMO), full dimensional MIMO (FD-MIMO), array antennas, and large scale antennas which are superior to radio frequency) devices, antennas, orthogonal frequency division multiplexing (OFDM) in terms of coverage need to be developed. In addition, new technologies such as metamaterial-based lenses and antennas, high-dimensional spatial multiplexing technology using orbital angular momentum (OAM), and reconfigurable intelligent surface (RIS) are being discussed to improve the coverage of terahertz band signals.

In addition, for frequency efficiency improvement and system network improvement in a 6G communication system, development is underway of a full duplex technology in which an uplink and a downlink simultaneously utilize the same frequency resource at the same time. Development is also underway of network technologies in which a satellite and high-altitude platform stations (HAPS) are integrally utilized, a network structure innovation technology supporting mobile base stations, etc. and enabling network operation optimization and automation, a dynamic spectrum sharing technology through collision aversion based on prediction of spectrum usage, an artificial intelligence (AI)-based communication technology that realizes system optimization by utilizing AI from the design stage and internalizing end-to-end AI support functions, and a next-generation distributed computing technology that realizes services of a complexity exceeding the limitations of terminal computing ability, by utilizing ultra-high-performance communication and computing resources (mobile edge computing (MEC), cloud, etc.). In addition, design of a new protocol to be used in the 6G communication system is being continuously made for implementation of a hardware-based security environment, development of mechanisms for the safe use of data, and development of technologies for maintaining privacy, attempts for further strengthening the connectivity between devices, further optimizing the network, promoting the implementation via software of network entities, and increasing the openness of wireless communication.

Due to research and development of the 6G communication system, a next hyper-connected experience is expected to become possible through hyper-connectivity of the 6G communication system which includes connection between things and also connection between humans and things. In detail, it is expected that services such as truly immersive extended reality (true immersive XR), high-fidelity mobile hologram, and digital replication can be provided through the 6G communication system. In addition, services such as remote surgery, industrial automation, and emergency response through security and reliability enhancement are provided through the 6G communication system, so the 6G communication system is going to be applied to various fields such as industry, medical care, automobiles, and home appliances.

### SUMMARY

The disclosure has been made to address at least the above-mentioned problems and/or disadvantages and to provide at least the advantages described below.

An aspect of the disclosure is to provide an apparatus and methods for supporting roaming of a terminal in a wireless communication system.

In accordance with an aspect of the disclosure, a method is provided for a user equipment (UE) that includes receiving roaming information including visited public land mobile network (PLMN) information from an access and mobility management function (AMF); selecting a PLMN among at least one PLMN identified based on verification of the roaming information; transmitting, to a session management function (SMF), a message to release a protocol data unit (PDU) session previously established at the UE; performing a PDU session release based on a response message for the transmitted message; and transmitting a message to register the selected PLMN.

The message to release the PDU session may include a suspend indication notifying that transmission of a PDU session establishment request is suspended.

The method may further include setting a timer to release the PDU session, with the PDU session being released upon expiry of the timer.

The message to release the PDU session may include a PDU session release request message, and the method may further include receiving the response message including a PDU session release command from the SMF; and in case that the PDU session is released based on the PDU session release command, transmitting a message indicating completion of the PDU session release to the SMF.

In accordance with another aspect of the disclosure, a method is provided for an SMF that includes receiving, from a user equipment (UE), a message to release a PDU session previously established at the UE, to the SMF; and identifying that the PDU session is released at the UE based on the received message, with the message to release the PDU session being received from the UE based on verification of roaming information including PLMN information.

The message to release the PDU session may include a suspend indication notifying that transmission of a PDU session establishment request is suspended.

The message to release the PDU session may include a PDU session release request message, and the method may further include transmitting a response message including a PDU session release command to the UE and, in case that the PDU session is released based on the PDU session release command, receiving a message indicating completion of the PDU session release from the UE.

In accordance with another aspect of the disclosure, a UE is provided, which includes a transceiver and at least one processor coupled with the transceiver, with the at least one processor being configured to receive roaming information including PLMN information from an AMF; select a PLMN among at least one PLMN identified based on verification of the roaming information; transmit, to an SMF, a message to release a PDU session previously established at the UE; perform a PDU session release based on an expiry of a timer set at the UE or a response message for the transmitted message; and transmit a message to register the selected PLMN.

In accordance with another aspect of the disclosure, an SMF is provided, which includes a transceiver and at least one processor coupled with the transceiver, the at least one processor being configured to receive, from a UE, a message to release a PDU session previously established at the UE, to an SMF, and identify that the PDU session is released at the UE based on the received message, with the message to release the PDU session being received from the UE based on verification of roaming information including PLMN information.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates an embodiment of a terminal and a network environment for supporting data communication of the terminal in a roaming state of the terminal in a 5G network, according to an embodiment;

FIG. 2 is a flowchart of a procedure for supporting data communication of a terminal in a roaming state of the terminal in a 5G network, according to an embodiment;

FIG. 3 is a flowchart of a procedure for supporting data communication of a terminal in a roaming state of the terminal in a 5G network, according to an embodiment;

FIG. 4 is a flowchart of a procedure for supporting data communication of a terminal in a roaming state of the terminal in a 5G network, according to an embodiment;

FIG. 5 is a structural diagram of a terminal according to an embodiment; and

FIG. 6 is a structural diagram of a network entity according to an embodiment.

### DETAILED DESCRIPTION

Hereinafter, embodiments of the disclosure will be described in detail with reference to the attached drawings. While describing the embodiments well known details are omitted to more clearly convey the gist of the disclosure.

For the same reasons, some elements are exaggerated, omitted, or schematically illustrated in the attached drawings. Also, a size of each element does not entirely reflect a real size of the element. In the drawings, like elements are denoted by like reference numerals.

Throughout the disclosure, the expression “at least one” of a, b or c indicates only a, only b, only c, both a and b, both a and c, both b and c, all of a, b, and c, or variations thereof.

The advantages and features of the disclosure and methods of achieving the advantages and features will be described more fully with reference to the accompanying drawings, in which embodiments are provided. The disclosure may, however, be embodied in many different forms and should not be construed as limited to embodiments set forth herein.

It will be understood that blocks in flowcharts or combinations of the flowcharts may be performed by computer program instructions.

Also, each block of the flowchart illustrations may represent a module, segment, or portion of code, which includes one or more executable instructions for implementing the specified logical function(s). It should also be noted that in some alternative implementations, the functions noted in the blocks may occur out of the order shown. For example, two blocks shown in succession may in fact be executed substantially concurrently or the blocks may sometimes be executed in the reverse order, depending upon the functionality involved.

As used herein, the term unit denotes a software element or a hardware element such as a field-programmable gate array (FPGA) or an application-specific integrated circuit (ASIC), and performs a certain function. However, unit does not mean to be limited to software or hardware. The term unit may be configured to be in an addressable storage medium or configured to operate one or more processors. Thus, unit may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in components and units may be combined into fewer components and units, or further separated into additional components and units. Further, components and units may be implemented to operate one or more central processing units (CPUs) in a device or a secure multimedia card. Also, the unit may include at least one processor.

Hereinafter, terms indicating a connection node, terms indicating network entities, terms indicating network functions, terms indicating messages, terms indicating an interface between network entities, and terms indicating various pieces of identification information used herein are exemplified for convenience of explanation. Accordingly, the disclosure is not limited to the terms described below, but other terms indicating objects having equal technical meanings may be used.

Hereinafter, some terms and names defined in the 3rd generation partnership project (3GPP) long term evolution (LTE) standard, or terms and names changed based on the same may be used for convenience of explanation. However, the disclosure is not limited to the terms and names described above, and may also be applied to systems following other standards. In the disclosure, an evolved node B (eNB) may be interchangeably used with a next generation node B (gNB) for convenience of explanation. That is, a base station described as an eNB may refer to a gNB. Also, the term terminal may refer to other wireless communication devices as well as mobile phones, narrowband Internet of Things (NB-IoT) devices, and sensors.

Although embodiments will be primarily focused on communication standards defined by the 3rd generation partnership project (3GPP), the subject matter of the disclosure may also be applicable to other communication systems with a similar technical background with minor changes without significantly departing from the scope of the disclosure, which may be possible under the determination of those of ordinary skill in the art to which the disclosure pertains.

In the 5G or new radio (NR) system, an AMF that is a management entity for managing mobility of a terminal and an SMF that is an entity for managing a session are separate. Accordingly, unlike a 4G LTE communication system in which a mobility management entity (MME) performs mobility management and session management together, in the 5G or NR system, an entity performing mobility management and an entity performing session management are separate. Accordingly, a communication method and a communication management method between a terminal and a network entity have changed.

In the 5G or NR system, with respect to non 3GPP access, via non-3GPP inter working function (N3IWF), mobility management may be performed by an AMF and session management may be performed by an SMF. In addition, the AMF may process security-related information, which is an important element in mobility management.

As described above, in the 4G LTE system, an MME is in charge of both mobility management and session management together. In the 5G or NR system, a non-standalone architecture for performing communication using a network entity of the 4G LTE system together may be supported.

When the terminal is in a roaming state, for a public land mobile network (PLMN) that was selected earlier, a home PLMN (HPLMN) may forcibly move the terminal to another PLMN for service improvement or economic reasons such as charging. In this case, there may be an ongoing communication session in a PLMN previously selected by the terminal and, here, seamless processing for the ongoing communication session is required. That is, it is necessary to enable a status of the terminal to be able to allow communication in a new PLMN.

In addition, a network needs to perform information management for a terminal, processing of mobility of the terminal, and processing for a data communication session of the terminal. In order to enable an HPLMN to transmit, through non-access stratum (NAS) signaling on a control plane, relevant information to a terminal which is in a visited PLMN (VPLMN) when the terminal selects an operator PLMN for data communication by roaming in a VPLMN, that is, a visited network.

Therefore, a method is provided for information management for a terminal in a network, processing of mobility of a terminal, and processing of a data communication session of a terminal, with the method being used for an HPLMN to transmit, through NAS signaling on a control plane, relevant information to a terminal, which is in a VPLMN, for the terminal to select an operator PLMN for data communication by roaming in the VPLMN, i.e., a visited network. In addition, when transmitting relevant information to the terminal, a method is provided of protecting information that is transmitted to the terminal and a method is provided of decrypting protected information and subsequently performing data communication or terminal registration depending on whether verification of the information succeeds or fails. In addition, when there is data communication that a terminal was previously performing, a method is provided of stopping or continuing the data communication and a procedure therefor is provided as information about PLMN to be newly accessed is transmitted to the terminal and the terminal succeeds or fails to verify the information, thereby improving network communication performance through protocol efficiency, and more efficiently performing communication.

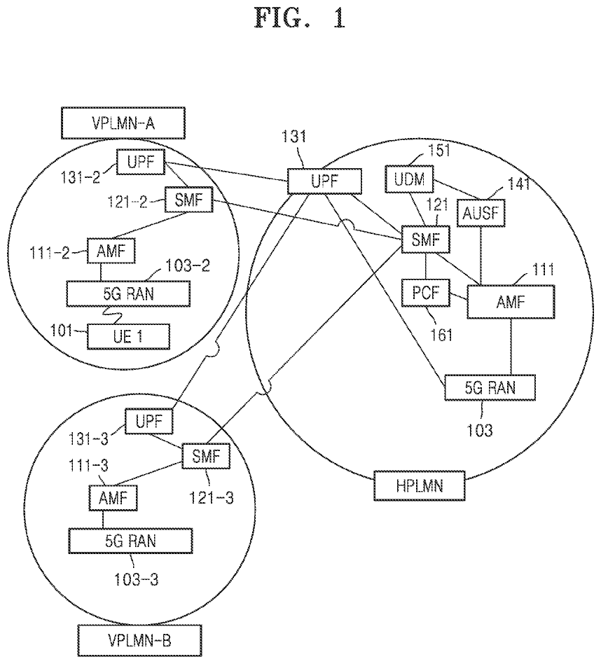

FIG. 1 illustrates an embodiment of a terminal and a network environment for supporting data communication of the terminal in a roaming state of the terminal in a 5G network, according to an embodiment.

Referring to FIG. 1, a 5G or NR core network may include network entities such as a user plane function (UPF) 131, an SMF 121, an AMF 111, a 5G radio access network (RAN) 103, a user data management (UDM) 151, a policy control function (PCF) 161, and the like. To authenticate these entities, the 5G or NR core network may include entities such as an authentication server function (AUSF) entity 141, an authentication, authorization and accounting (AAA) entity, and the like. A UE (user equipment, terminal) 101 may access the 5G core network through a base station (5G RAN, Radio Access Network, base station, BS) 103, 103-2, 103-3. When the UE communicates through non 3GPP access, there may be an N3IWF. When using non3GPP access, session management may be controlled by the UE, non 3GPP access, N3IWF, and SMF, and mobility management may be controlled through UE, non 3GPP access, N3IWF, and AMF.

In the 5G or NR system, an entity to perform mobility management and session management is divided into AMF 111 or 111-2 and SMF 121 or 121-2. For the 5G or NR system, a standalone deployment structure in which communication is performed only with 5G or NR entities and a non-standalone deployment structure in which both 4G entities and 5G or NR entities are used are taken into account.

Although a communication network on which the disclosure is based assumes networks of 5G and 4G LTE, the disclosure may also be applied when the same concept is applied to other systems within a scope that can be understood by a person with ordinary skill in the art.

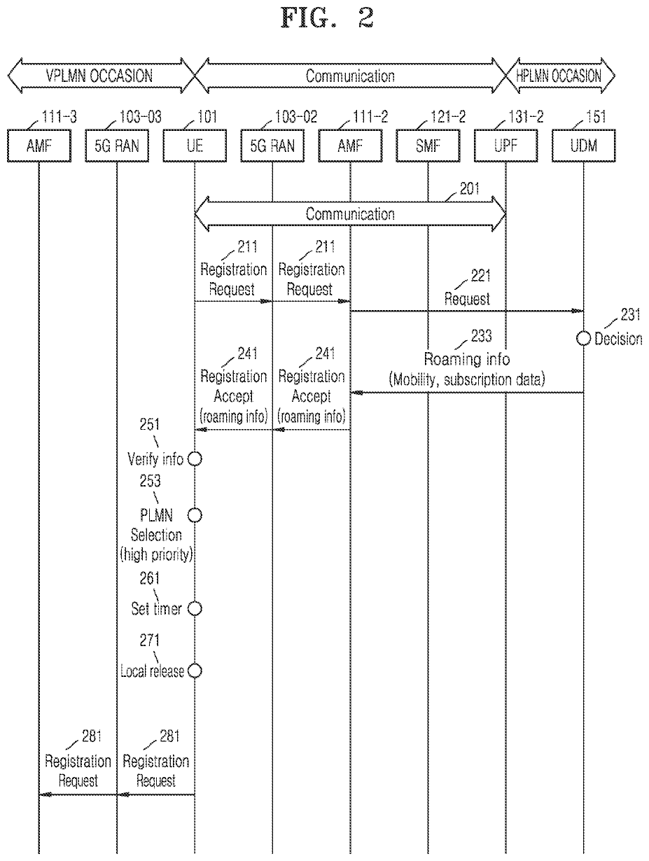

FIG. 1 illustrates a situation in which a terminal was in a HPLMN, and then roamed and moved to VPLMN-A. Also, in VPLMN-A, the terminal may select one PLMN to perform communication. In this situation, the HPLMN may induce the user equipment to forcibly access another PLMN for reasons such as charging and service improvement. In this case, how to process a previously communicating session, etc., will be described in detail with reference to FIGS. 2 to 6.

FIG. 2 is a flowchart of a procedure for supporting data communication of a terminal in a roaming state of the terminal in a 5G network, according to an embodiment.

Regarding FIG. 2, the terminal formerly in an HPLMN, roamed and moved to a VPLMN. In the VPLMN, the terminal performs communication by selecting one PLMN. In this situation, the HPLMN may induce the user equipment to forcibly access another PLMN for reasons such as charging and service improvement. In this case, how to process a previously communicating session is described in the present embodiment, with the terminal described as a UE, for convenience.

In step 201, the UE 101 is performing communication in a currently registered VPLMN, and the AMF 111-2 and the SMF 121-2 are performing control.

In step 211, the UE 101 may transmit a registration request message to the AMF 111-2. Also in step 211, the registration request message may be transmitted to the AMF 111-2 through a 5G RAN 103-02.

In step 221, to determine information about VPLMN, or the like, in which the UE 101 may register, the AMF 111-2 may access an HPLMN in which the UE 101 is registered, and transmit, to the UDM 151 of the HPLMN, a request message requesting VPLMN-related information, subscription-related information of the UE 101.

In step 231, the UDM 151 determines whether to transmit information related to roaming, to the UE 101, and what kind of information to transmit when information is to be transmitted. For example, the UDM 151 of the HPLMN determines whether to transmit, to the UE 101, mobility-related information, subscription-related information, etc. with regard to roaming, and determines which information among roaming-related information is to be transmitted.

In step 233, the UDM 151 of the HPLMN may transmit, to the AMF 111-2 of the VPLMN, information related to roaming, such as mobility-related information, changed subscription data information, information about VPLMN which the terminal is to access, the information to be transmitted to the UE 101. In particular, in order to update information about VPLMN that can be selected by the UE with regard to roaming, the UDM 151 of the HPLMN may transmit the corresponding information using a NAS message. Through a NAS message, information necessary for selecting a PLMN, such as a VPLMN-related PLMN list and an access technology accessible by the UE 101 (e.g., 4G LTE, 5G) may be transmitted together.

In step 241, the AMF 111-2 may transmit a registration accept message to the UE 101. Through a registration accept message, roaming-related information received by the AMF 111-2 of the VPLMN from the UDM 151 of the HPLMN of the UE 101 may be transmitted to the UE. The information may be transmitted after being secured. That is, the roaming-related information received by the AMF 111-2 of the VPLMN from the UDM 151 of the HPLMN of the UE 101 may be transmitted as security-protected information.

In step 251, the UE 101 may verify the roaming-related information included in the registration accept message received from the AMF 111-2. In particular, the UE 101 may perform security verification on the security-protected, roaming-related information, and process roaming-related information included in the received registration accept message, based on whether the security verification fails or succeeds.

When the security verification fails, the UE 101 may store received PLMN-related information as a forbidden PLMN in a forbidden PLMN list. For example, although the UE 101 has received, from HPLMN A, information about VPLMN C through a registration accept message in addition to information about VPLMN B which the UE 101 is currently accessing, when security verification has failed as a result of performing verification of security protection on the received information, the UE 101 may store VPLMN C in the forbidden PLMN list of the UE 101.

When security verification is successful, the UE 101 may store VPLMN C in a registerable PLMN list maintained by the UE 101.

In step 253, the UE 101 may perform PLMN selection. Here, the UE 101 may perform PLMN selection by selecting a high priority PLMN.

In step 261, the UE 101 may set a timer to release a PDU session that is previously performed by the UE 101.

In step 271, when there is a PDU session that the UE 101 is establishing with the current VPLMN, the UE 101 may locally release the corresponding PDU session. That is, the UE 101 may release the corresponding session after a certain period of time without communication with a network. Alternatively, the UE 101 may release the corresponding session when a set timer value expires.

In step 281, the UE 101 may transmit a registration request message to an AMF 111-3. In step 281, the UE 101 may select, from among the roaming-related information received in step 241, a PLMN in the registrable PLMN list among VPLMNs in which the UE 101 may register, and transmit a registration request. Also in step 281, the registration request message may be transmitted to the AMF 111-3 through a 5G RAN 103-03.

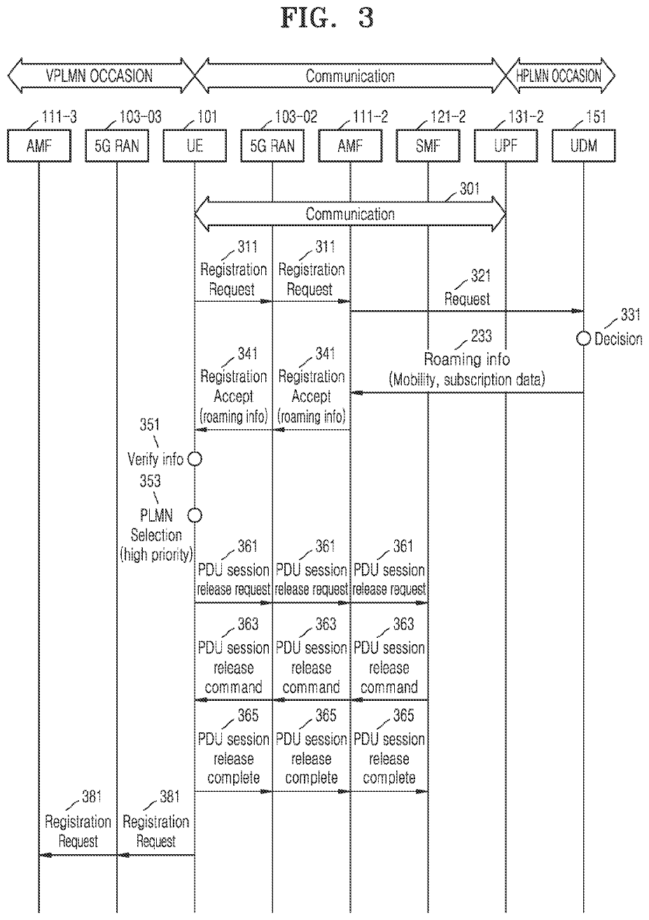

FIG. 3 is a flowchart of a procedure for supporting data communication of a terminal in a roaming state of the terminal in a 5G network, according to an embodiment.

Regarding FIG. 3, the terminal formerly in an HPLMN roamed and moved to a VPLMN. In the VPLMN, the terminal performs communication by selecting one PLMN. In this situation, the HPLMN may induce the user equipment to forcibly access another PLMN for reasons such as charging and service improvement. In this case, how to process a previously communicating session or the like is described.

In step 301, the UE 101 is performing communication in a currently registered VPLMN, and the AMF 111-2 and the SMF 121-2 are performing control during communication to UPF 131-2.

In step 311, the UE 101 may transmit a registration request message to the AMF 111-2. Also in step 311, the registration request message may be transmitted to the AMF 111-2 through the 5G RAN 103-02.

In step 321, to determine information about VPLMN, or the like, in which the UE 101 may register, the AMF 111-2 may access an HPLMN in which the UE 101 is registered, and transmit, to the UDM 151 of the HPLMN, a request message requesting VPLMN-related information, subscription-related information of the UE 101.

In step 331, the UDM 151 determines whether to transmit roaming-related information to the UE 101, and what kind of information to transmit when roaming-related information is to be transmitted. For example, the UDM 151 of the HPLMN determines whether to transmit, to the UE 101, mobility-related information, subscription-related information, etc. with regard to roaming, and determines which information among roaming-related information is to be transmitted.

In step 333, the UDM 151 of the HPLMN may transmit, to the AMF 111-2 of the VPLMN, roaming-related information, such as mobility-related information, changed subscription data information, information about VPLMN which the UE 101 is to access, the information to be transmitted to the UE 101. In particular, to update information about VPLMN that the UE 101 may select with regard to roaming, the roaming-related information may be transmitted using a NAS message. Through the NAS message, information necessary for selecting a PLMN, such as a VPLMN-related PLMN list and an access technology accessible by the UE (e.g., 4G LTE, 5G) may be transmitted together.

In step 341, the AMF 111-2 may transmit a registration accept message to the UE 101. Through the registration accept message, roaming-related information received by the AMF 111-2 of the VPLMN from the UDM 151 of the HPLMN of the UE 101 may be transmitted to the UE 101. The information may be transmitted after being secured. That is, the roaming-related information received by the AMF 111-2 of the VPLMN from the UDM 151 of the HPLMN of the UE 101 may be transmitted as security-protected information.

In step 351, the UE 101 may verify the roaming-related information included in the registration accept message received from the AMF 111-2. In particular, the UE 101 may perform security verification on the security-protected, roaming-related information, and process roaming-related information included in the received registration accept message, based on whether the security verification fails or succeeds.

When the security verification fails, the UE 101 may store the received PLMN-related information as a forbidden PLMN in a forbidden PLMN list. For example, although the UE 101 has received, from HPLMN A, information about VPLMN C through a registration accept message, in addition to information about VPLMN B which the UE 101 is currently accessing, when security verification has failed as a result of performing verification of security protection on the received information, the UE 101 may store VPLMN C in the forbidden PLMN list maintained by the UE 101.

When security verification is successful, the UE 101 may store VPLMN C in a registerable PLMN list maintained by the UE 101.

In step 353, the UE 101 may perform PLMN selection. Here, the UE 101 may perform PLMN selection by selecting a high priority PLMN.

In step 361, the UE 101 may transmit a PDU session release request to the SMF 121-2 through the 5G RAN 103-02, the AMF 111-2 in order to release a PDU session that is previously performed by the UE 101.

In step 363, upon receiving the PDU session release request from the UE 101, the SMF 121-2 may transmit a PDU session release command to the UE 101 via the AMF 111-2, the 5G RAN 103-02.

In step 365, upon receiving the PDU session release command from the SMF 121-2, the UE 101 may release the PDU session. In addition, the UE 101 may transmit a PDU session release complete message to the SMF 121-2 via the 5G RAN 103-02 and the AMF 111-2.

In step 381, the UE 101 may transmit a registration request message to the AMF 111-3. In step 381, the UE 101 may select, from among the roaming-related information received in step 341, a PLMN in the registrable PLMN list among VPLMNs in which the UE may register, and transmit a registration request. Also in step 381, the registration request message may be transmitted to the AMF 111-3 through the 5G RAN 103-03.

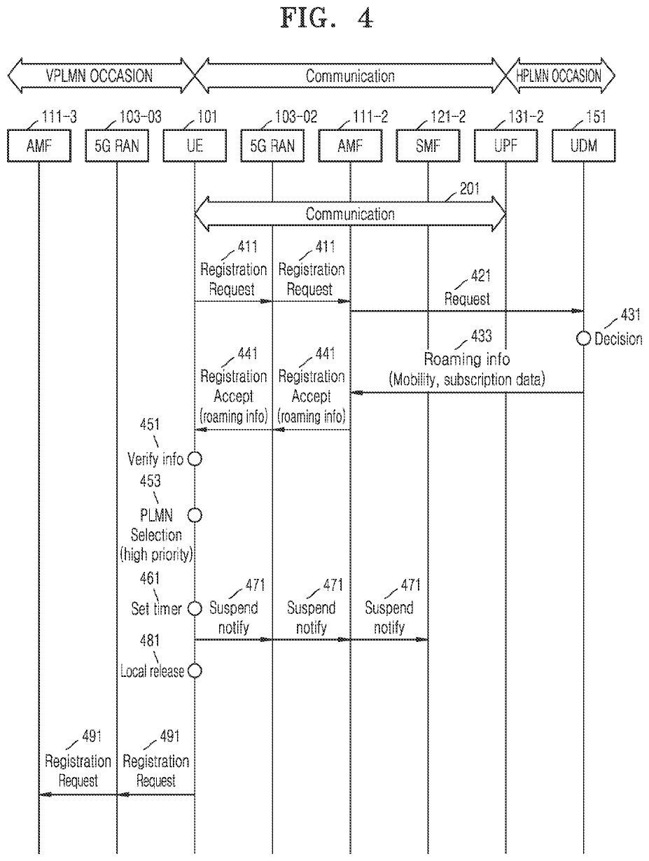

FIG. 4 is a flowchart of a procedure for supporting data communication of a terminal in a roaming state of the terminal in a 5G network, according to an embodiment.

Regarding FIG. 4, the terminal formerly in an HPLMN roamed and moved to a VPLMN. In the VPLMN, the terminal performs communication by selecting one PLMN. In this situation, the HPLMN may induce the user equipment to forcibly access another PLMN for reasons such as charging and service improvement. In this case, how to process a previously communicating session or the like is described.

In step 401, the UE 101 is performing communication in a currently registered VPLMN, and the AMF 111-2 and the SMF 121-2 are performing control.

In step 411, the UE 101 may transmit a registration request message to the AMF 111-2. Also in step 411, the registration request message may be transmitted to the AMF 111-2 through the 5G RAN 103-02.

In step 421, to determine information about VPLMN, or the like, in which the UE 101 may register, the AMF 111-2 may access an HPLMN in which the UE 101 is registered, and transmit, to the UDM 151 of the HPLMN, a request message requesting VPLMN-related information, subscription-related information of the UE 101.

In step 431, the UDM 151 determines whether to transmit roaming-related information to the UE 101, and determines what kind of information to transmit when roaming-related information is to be transmitted. For example, the UDM 151 of the HPLMN determines whether to transmit, to the UE 101, mobility-related information, subscription-related information, etc. with regard to roaming, and determines which information among the roaming-related information is to be transmitted.

In step 433, the UDM 151 of the HPLMN may transmit, to the AMF 111-2 of the VPLMN, roaming-related information, such as mobility-related information, changed subscription data information, information about VPLMN which the UE 101 is to access, the information to be transmitted to the UE 101. In particular, to update information about VPLMN that the UE 101 may select with regard to roaming, the roaming-related information may be transmitted using a NAS message. Through a NAS message, information necessary for selecting a PLMN, such as a VPLMN-related PLMN list and an access technology accessible by the UE (e.g., 4G LTE, 5G) may be transmitted together.

In step 441, the AMF 111-2 may transmit a registration accept message to the UE 101. Through the registration accept message, roaming-related information received by the AMF 111-2 of the VPLMN from the UDM 151 of the HPLMN of the UE 101 may be transmitted to the UE 101. The information may be transmitted after being secured. That is, the roaming-related information received by the AMF 111-2 of the VPLMN from the UDM 151 of the HPLMN of the UE 101 may be transmitted as security-protected information.

In step 451, the UE 101 may verify the roaming-related information included in the registration accept message received from the AMF 111-2. In particular, the UE 101 may perform security verification on the security-protected, roaming-related information, and process roaming-related information included in the received registration accept message, based on whether the security verification fails or succeeds.

When the security verification fails, the UE 101 may store the received PLMN-related information as a forbidden PLMN in a forbidden PLMN list. For example, although the UE 101 has received, from HPLMN A, information about VPLMN C through a registration accept message, in addition to information about VPLMN B which the UE 101 is currently accessing, when security verification has failed as a result of performing verification of security protection on the received information, the UE 101 may store VPLMN C in the forbidden PLMN list maintained by the UE 101.

When security verification is successful, the UE 101 may store VPLMN C in a registerable PLMN list maintained by the UE 101.

In step 453, the UE 101 may perform PLMN selection. Here, the UE 101 may perform PLMN selection by selecting a high priority PLMN.

In step 461, the UE 101 may set a timer to release a PDU session that is previously performed by the UE 101.

In step 471, the UE 101 may request the SMF 121-2 via the 5G RAN 103-02, the AMF 111-2, to suspend the PDU session, or may transmit a suspend notify notifying that the UE 101 is going to release the previous PDU session. Alternatively, the UE 101 may transmit, to the SMF 121-2 via the 5G RAN 103-02 and the AMF 111-2, a suspend notify notifying that transmission of a PDU session establishment request is suspended. Alternatively, the UE 101 may transmit, to the SMF 121-2 via the 5G RAN 103-02 and the AMF 111-2, indication information notifying that transmission of a PDU session establishment request is suspended.

In step 481, when there is a PDU session that the UE 101 has established in the current VPLMN, the UE 101 may locally release the corresponding PDU session.

In step 491, the UE 101 may transmit a registration request message to the AMF 111-3. In step 491, the UE 101 may select, from among the roaming-related information received in step 441, a PLMN in the registrable PLMN list among VPLMNs, in which the UE may register, and transmit a registration request. Also in step 491, the registration request message may be transmitted to the AMF 111-3 through the 5G RAN 103-03.

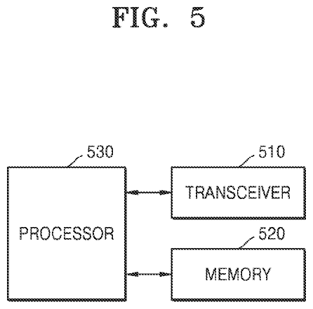

FIG. 5 is a structural diagram of a UE according to an embodiment.

Referring to FIG. 5, the UE may include a transceiver 510, a memory 520, and a processor 530. The transceiver 510, the memory 520, and the processor 530 of the UE may operate according to the aforementioned communication method of the UE. However, elements of the UE are not limited thereto. For example, the UE may include fewer or a greater number of elements than described above. Moreover, the transceiver 510, the memory 520, and the processor 530 may be implemented in a single chip.

The transceiver 510 is a collective term of a UE transmitter and a UE receiver, and may transmit or receive a signal to or from a base station or a network entity. The signal transmitted/received to/from the base station may include control information and data. For this, the transceiver 510 may include an RF transmitter for up-converting the frequency of a signal to be transmitted and amplifying the signal and an RF receiver for low-noise amplifying a received signal and down-converting the frequency of the received signal. This, however, is merely an example, and the elements of the transceiver 510 are not limited to the RF transmitter and RF receiver.

In addition, the transceiver 510 may include a wired or wireless transceiver, and various elements for transmitting or receiving a signal.

In addition, the transceiver 510 may receive a signal on a wireless channel and output the signal to the processor 530, or transmit a signal output from the processor 530 on a wireless channel.

In addition, the transceiver 510 may receive a communication signal and output the same to a processor, and transmit a signal output from the processor to the network entity via a wired or wireless network.

The memory 520 may store a program and data required for operation of the UE. The memory 520 may store control information or data included in a signal obtained by the UE. The memory 520 may include a storage medium such as a read only memory (ROM), a random access memory (RAM), a hard disk, a compact disk ROM (CD-ROM), and a digital versatile disc (DVD), or a combination of storage media.

The processor 530 may control a series of processes for the UE to be operated according to the embodiments described above. The processor 530 may include at least one or more processors. For example, the processor 530 may include a communication processor (CP) for controlling communication and an application processor (AP) for controlling a higher layer such as an application program, and a layer may also be referred to as an entity.

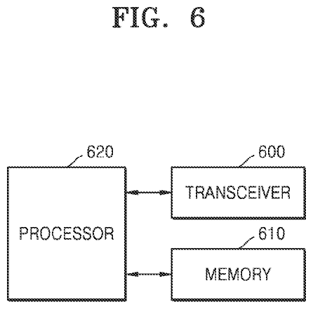

FIG. 6 is a structural diagram of a network entity according to an embodiment.

Referring to FIG. 6, the network entity includes a transceiver 610, a memory 620, and a processor 630. The processor 630, the transceiver 610, and the memory 620 of the network entity may operate according to the afore-described communication method. However, elements of the network entity are not limited to an example described above. For example, the network entity may include fewer or a greater number of elements than described above. Moreover, the transceiver 610, the memory 620, and the processor 630 may be implemented in a single chip. The network entity may include a network function (NF) such as an AMF, an SMF, a PCF, a network exposure function (NEF), a UDM, a UPF, etc., as described above. In addition, the network entity may include a base station.

The transceiver 610 is a collective term of a transmitter of a network entity and a receiver of a network entity, and may transmit or receive a signal to or from a UE or another network entity. The signal transmitted or received may include control information and data. For this, the transceiver 610 may include an RF transmitter for up-converting the frequency of a signal to be transmitted and amplifying the signal and an RF receiver for low-noise amplifying a received signal and down-converting the frequency of the received signal. This, however, is merely an example, and the elements of the transceiver 610 are not limited to the RF transmitter and RF receiver. The transceiver 610 may include a wired or wireless transceiver, and various elements for transmitting or receiving a signal.

In addition, the transceiver 610 may receive a signal on a communication channel (e.g., a wireless channel) and output the signal to the processor 630, or transmit a signal output from the processor 630 on a communication channel.

In addition, the transceiver 610 may receive a communication signal and output the same to a processor, and transmit a signal output from the processor to a UE or a network entity via a wired or wireless network.

The memory 620 may store programs and data required for the network entity to operate. Also, the memory 620 may store control information or data included in a signal obtained by the network entity. The memory 620 may include a storage medium such as ROM, RAM, a hard disk, CD-ROM, and a DVD, or a combination of the storage media.

The processor 630 may control a series of processes for the network entity to be operated according to the embodiments. The processor 630 may include at least one or more processors. The methods according to the embodiments as described herein may be implemented as hardware, software, or a combination of hardware and software.

When implemented in software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments herein.

The programs (e.g., software modules or software) may be stored in RAM, non-volatile memory including flash memory, ROM, electrically erasable programmable read-only memory (EEPROM), a magnetic disc storage device, CD-ROM, a DVD, another type of optical storage device, or a magnetic cassette. Alternatively, the programs may be stored in memory including a combination of some or all of the above-mentioned storage media. A plurality of such memories may be included.

The programs may also be stored in an attachable storage device which is accessible through a communication network such as the Internet, an intranet, a local area network (LAN), a wide area network (WAN), or a storage area network (SAN), or a combination thereof. Such a storage device may access, via an external port, an apparatus that performs embodiments. Furthermore, an additional storage device on the communication network may access an apparatus that performs embodiments.

In the above described embodiments, an element or elements included in the disclosure are expressed in a singular or plural form depending on the described embodiments. However, the singular or plural form is selected properly for a situation assumed for convenience of description and does not limit the disclosure, and elements expressed in a plural form may include a single element and an element expressed in a singular form may include a plurality of elements.

Accordingly, when a UE roams from an HPLMN to a VPLMN, roaming of the UE, PLMN selection, processing of mobility of the UE, processing of the UE's ongoing session may be supported efficiently.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. A method performed by a user equipment (UE), the method comprising:
receiving roaming information including visited public land mobile network (PLMN) information from an access and mobility management function (AMF);
selecting a PLMN among at least one PLMN identified based on verification of the roaming information;
transmitting, to a session management function (SMF), a message to release a protocol data unit (PDU) session previously established at the UE;
performing a PDU session release based on an expiry of a timer set at the UE or a response message for the transmitted message; and
transmitting a message to register the selected PLMN.

2. The method of claim 1, wherein the message to release the PDU session includes a suspend indication notifying that transmission of a PDU session establishment request is suspended.

3. The method of claim 2, further comprising setting the timer to release the PDU session.

4. The method of claim 1, wherein the message to release the PDU session includes a PDU session release request message, and
wherein the method further comprises:
receiving the response message including a PDU session release command from the SMF; and
in case that the PDU session is released based on the PDU session release command, transmitting a message indicating completion of the PDU session release to the SMF.

5. A method performed by session management function (SMF), the method comprising:
receiving, from a user equipment (UE), a message to release a protocol data unit (PDU) session previously established at the UE; and
identifying that the PDU session is released at the UE based on the received message,
wherein the message to release the PDU session is received from the UE based on verification of roaming information including visited public land mobile network (VPLMN) information.

6. The method of claim 5, wherein the message to release the PDU session includes a suspend indication notifying that transmission of a PDU session establishment request is suspended.

7. The method of claim 5, wherein the message to release the PDU session includes a PDU session release request message, and
wherein the method further comprises:
transmitting a response message including a PDU session release command to the UE; and
in case that the PDU session is released based on the PDU session release command, receiving a message indicating completion of the PDU session release from the UE.

8. A user equipment (UE) comprising:
a transceiver; and
at least one processor coupled with the transceiver and configured to:
receive roaming information including visited public land mobile network (PLMN) information from an access and mobility management function (AMF),
select a PLMN among at least one PLMN identified based on verification of the roaming information,
transmit, to a session management function (SMF), a message to release a protocol data unit (PDU) session previously established at the UE,
perform a PDU session release based on an expiry of a timer set at the UE or a response message for the transmitted message, and
transmit a message to register the selected PLMN.

9. The UE of claim 8, wherein the message to release the PDU session includes a suspend indication notifying that transmission of a PDU session establishment request is suspended.

10. The UE of claim 9, wherein the at least one processor is further configured to:
set the timer to release the PDU session.

11. The UE of claim 8, wherein the message to release the PDU session includes a PDU session release request message, and
wherein the at least one processor is further configured to:
receive the response message including a PDU session release command from the SMF, and
in case that the PDU session is released based on the PDU session release command, transmit a message indicating completion of the PDU session release to the SMF.

12. A session management function (SMF) comprising:
a transceiver; and
at least one processor coupled with the transceiver and configured to:
receive, from a user equipment (UE), a message to release a protocol data unit (PDU) session previously established at the UE, and
identify that the PDU session is released at the UE based on the received message,
wherein the message to release the PDU session is received from the UE based on verification of roaming information including visited public land mobile network (VPLMN) information.

13. The SMF of claim 12, wherein the message to release the PDU session includes a suspend indication notifying that transmission of a PDU session establishment request is suspended.

14. The SMF of claim 12, wherein the message to release the PDU session includes a PDU session release request message, and
the at least one processor is further configured to:
transmit a response message including a PDU session release command to the UE, and
in case that the PDU session is released based on the PDU session release command, receive, from the UE, a message indicating completion of the PDU session release.
